(19) United States
(12) Patent Application Publication
(10) Pub. No.: US 2016/0369999 A1
(43) Pub. Date: Dec. 22, 2016

(54) Illuminated Novelty Decoration Assembly

(71) Applicant: Ron La Roque, Elk Grove, CA (US)

(72) Inventor: Ron La Roque, Elk Grove, CA (US)

(21) Appl. No.: 14/743,332

(22) Filed: Jun. 18, 2015

(51) Int. Cl. F21V 33/00; F21V 23/04; F21V 23/02; F21S 8/00; F21S 9/02

(52) U.S. Cl. CPC F21V 33/008; F21S 8/036; F21S 9/02; F21V 23/023; F21V 23/04; F21V 23/0471; F21V 33/0056; F21W 2121/00

(57) ABSTRACT

An illuminated novelty decoration assembly includes a panel that has a front side and a back side. A framework is attached to the front side and extends forward thereof. The framework includes a plurality of rods connected together such that the framework is formed in a shape of an animal head resembling a dear head with a pair of antlers. Each of a plurality of light emitters is positioned on the framework and is spaced from each other so that the light emitters form an outline of the animal head and the antlers. A power supply is electrically coupled to the light emitters. A switch is electrically coupled to the power supply and the light emitters. The switch is actuated to an on position to turn the light emitters on and is actuated to an off position to turn the light emitters off.

### BACKGROUND OF THE DISCLOSURE

### Field of the Disclosure

The disclosure relates to novelty devices and more particularly pertains to a new novelty device for providing humor and decoration with respect to traditional holiday decorations.

### SUMMARY OF THE DISCLOSURE

An embodiment of the disclosure meets the needs presented above by generally comprising a panel that has a front side and a back side. The panel is configured to be positioned on a wall surface. A framework is attached to the front side and extends forward thereof. The framework includes a plurality of rods connected together such that open spaces are defined between adjacent ones of the rods. The framework is formed in a shape of an animal head, which resembles a dear head, wherein the framework further is formed into a pair of antlers extending off of the animal head. Each of a plurality of light emitters is positioned on the framework and is spaced from each other so that the light emitters form an outline of the animal head and the antlers. A power supply is electrically coupled to the light emitters. A switch is electrically coupled to the power supply and the light emitters. The switch is actuated to an on position to turn the light emitters on and is actuated to an off position to turn the light emitters off.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of an illuminated novelty decoration assembly according to an embodiment of the disclosure.

FIG. 2 is a front view of an embodiment of the disclosure.

FIG. 3 is a side view of an embodiment of the disclosure.

FIG. 4 is a rear view of an embodiment of the disclosure.

FIG. 5 is a schematic view of an embodiment of the disclosure.

### DESCRIPTION OF THE PREFERRED EMBODIMENT

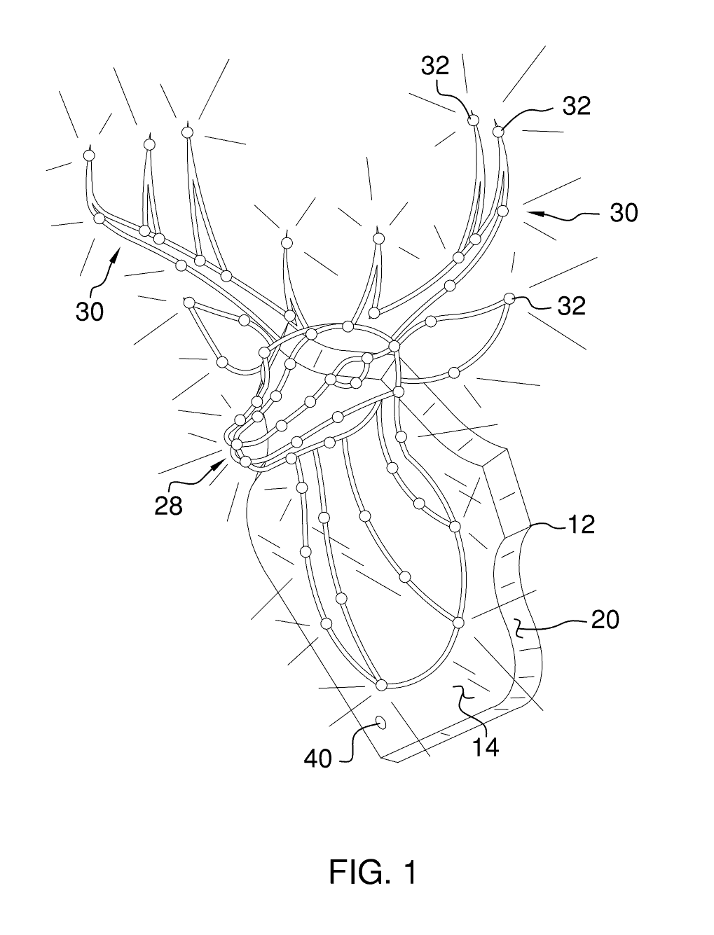

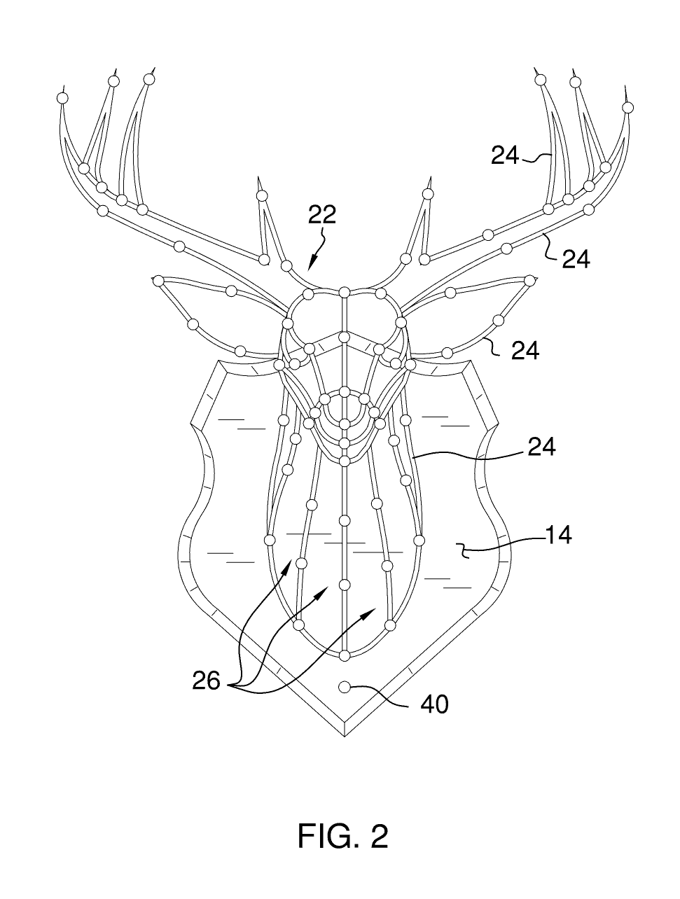

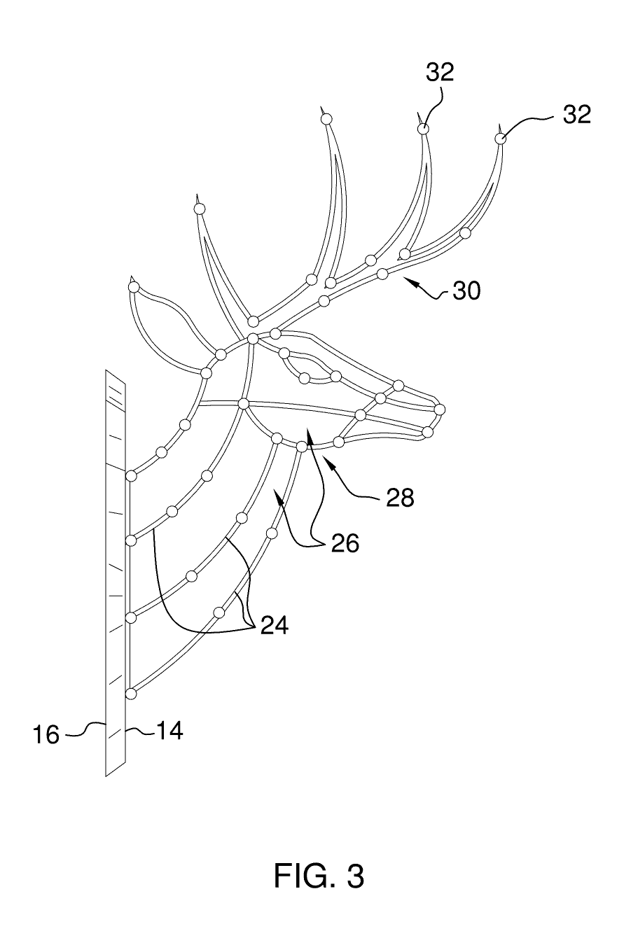

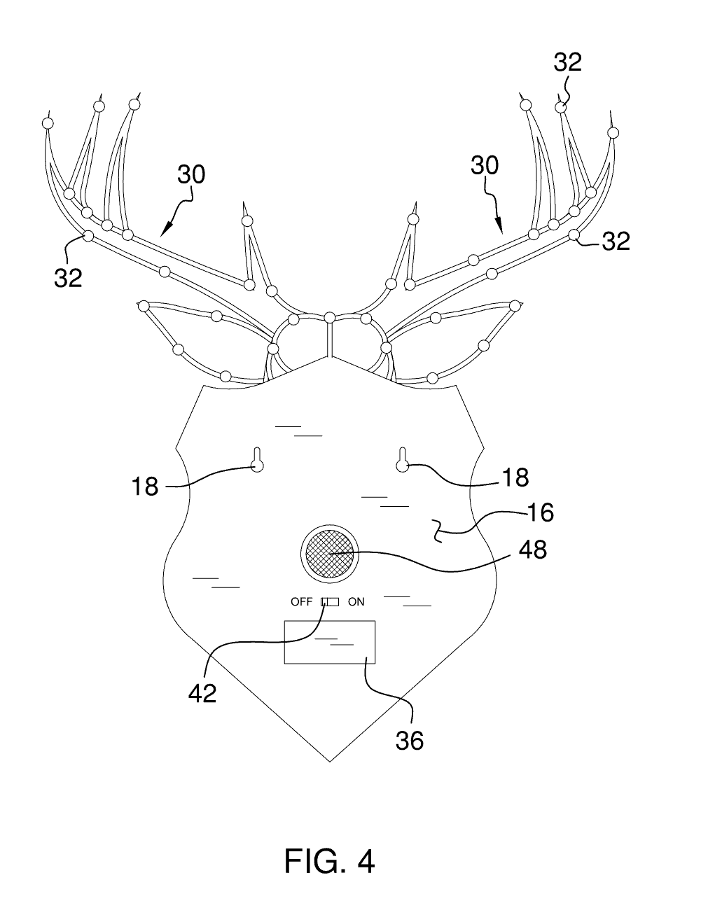

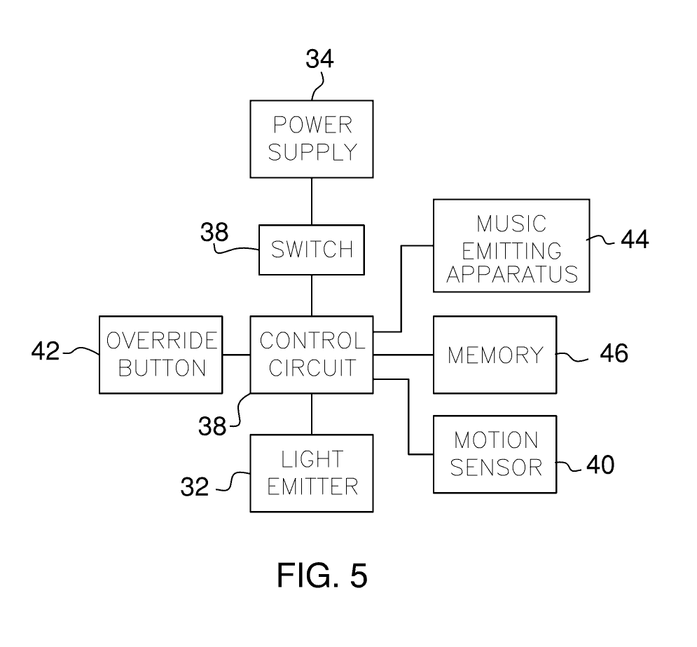

With reference now to the drawings, and in particular to FIGS. 1 through 5 thereof, a new novelty device embodying the principles and concepts of an embodiment of the disclosure and generally designated by the reference numeral 10 will be described.

As best illustrated in FIGS. 1 through 5, the illuminated novelty decoration assembly 10 generally comprises a panel 12 that has a front side 14 and a back side 16. The back side 16 has a mounting aperture 18 extending therein that may be used with conventional wall mounting fasteners, though brackets may also be attached to the back side 16. The panel 12 may be comprised of any rigid material including wood, plastics, metals and the like. The panel 12 may have a perimeter edge 20 having a decorative shape as shown in the Figures.

A framework 22 is attached to the front side 14 and extends forward thereof. The framework 22 includes a plurality of rods 24 connected together such that open spaces 26 are defined between adjacent ones of the rods 24. The rods 24 may be comprised of a metallic material or a plastic material. The framework 22 is formed in a shape of an animal head and the animal head 28 resembles a dear head. The framework 22 further is formed into a pair of antlers 30 extending off of the animal head 28. Such structures are conventional for lawn decorations though such decorations typically include an entire animal sculpture as opposed to only a head which is utilized here.

A plurality of light emitters 32 is provided and the light emitters 32 might comprise light emitting diodes. Each of the light emitters 32 is positioned on the framework 22 and the light emitters 32 are spaced from each other. Thus, the light emitters 32 form an outline of the animal head 28 and the antlers 30. A power supply 34 is electrically coupled to the light emitters 32 to provide electricity to the light emitters 32. The power supply 34 may comprise a battery mounted in the panel 12 that is accessible through a door 36 in the back side 16 of the panel 12.

A switch 38 is electrically coupled to the power supply 34 and the light emitters 32. The switch 38 is actuated to an on position to turn the light emitters 32 on and is actuated to an off position to turn the light emitters off 34. A control circuit 40 is electrically coupled to the switch 38. A motion sensor 40 may be mounted on front side 14 of the panel 12 and is electrically coupled to the control circuit 38. The control circuit 38 turns the switch 38 to the on position when the motion sensor 40 detects motion to define a motion activation, the control circuit 38 switches the switch 38 to the off position after a predetermined time of the motion activation. The predetermined amount of time may be between 30 seconds and 3 minutes or after a song has been played as will be described below.

An override button 42 is mounted on the panel 12 and is electrically coupled to the control circuit 38. The override button 42 is actuated to an on position to turn the light emitters on 32 or to an off position to turn the light emitters off 34. Thus the assembly 10 may be turned on without the motion detector 40 detecting motion. Alternatively the override button 42 may function as the switch 38 wherein no motion sensor is utilized and the assembly 10 is solely turned on or off with the override button 42.

A music emitting apparatus 44, which would include a conventional speaker 48, may also be mounted to the panel 12 and is electrically coupled to the control circuit 38. The music emitting apparatus 44 is turned on and audibly emits music when the light emitters 32 are turned on. Thus, the music emitting apparatus 44 will turn on whether the light emitters 32 are actuated on with either the motion sensor 40 or the override button 42. Additionally, a toggle actuator, not shown, may be utilized which is electrically coupled to the control circuit 38 to allow the user to select if music will play when the light emitters 32 are illuminated such that the assembly 10 may allow the user to have the light emitters on with the music off. The music emitting apparatus 44 includes an electronic memory 46 that has at least one song stored thereon. The song may comprise a holiday song such as one associated with Christmas. The electronic memory 46 is electrically coupled to the control circuit 38. The speaker 48 is electrically coupled to the control circuit 38 and may be mounted on back side 16 and face outwardly therefrom.

In use, the panel 12 is mounted on a wall by using the aperture 18, or apertures, to receive the head of a fastener extending from the wall. Alternatively, mounting brackets or other mounting means may be utilized which are placed on the back side 16 of the panel 12. The light emitters 32 and music emitting apparatus 44 may be thereafter be turned on when desired or when triggered by motion detected by the motion sensor 40.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An illuminated decoration comprising:
a panel having a front side and a back side, said panel being configured to be positioned on a wall surface;
a framework being attached to said front side and extending forward thereof, said framework including a plurality of rods connected together such that open spaces are defined between adjacent ones of said rods, said framework being formed in a shape of an animal head, said animal head resembling a dear head, said framework further being formed into a pair of antlers extending off of said animal head;
a plurality of light emitters, each of said light emitters being positioned on said framework and being spaced from each other, said light emitters forming an outline of said animal head and said antlers;
a power supply being electrically coupled to said light emitters; and
a switch being electrically coupled to said power supply and said light emitters, said switch being actuated to an on position to turn said light emitters on and being actuated to an off position to turn said light emitters off.

2. The illuminated decoration according to claim 1, wherein said power supply comprises a battery mounted in said panel, said back side having a door thereon for accessing said battery.

3. The illuminated decoration according to claim 1, further including:
a control circuit being electrically coupled to said switch;
a motion sensor being mounted on front side of said panel and being electrically coupled to said control circuit, said control circuit turning said switch to said on position when said motion sensor detects motion to define a motion activation, said control circuit switching said switch to said off position after a predetermined time of said motion activation.

4. The illuminated decoration according to claim 3, further including an override button being mounted on said panel and being electrically coupled to said control circuit, said override button being actuated to an on position to turn said light emitters on or to an off position to turn said light emitters off.

5. The illuminated decoration according to claim 3, further including a music emitting apparatus being mounted to said panel and being electrically coupled to said control circuit, said music emitting apparatus being turned on and audibly emitting music when said light emitters are turned on.

6. The illuminated decoration according to claim 2, further including a music emitting apparatus being mounted to said panel and being electrically coupled to said control circuit, said music emitting apparatus being turned on and audibly emitting music when said light emitters are turned on.

7. The illuminated decoration according to claim 1, further including:
a control circuit being electrically coupled to said switch;
a music emitting apparatus being mounted to said panel and being electrically coupled to said control circuit, said music emitting apparatus being turned on and audibly emitting music when said light emitters are turned on.

8. An illuminated decoration comprising:
a panel having a front side and a back side, said back side having a mounting aperture extending therein;
a framework being attached to said front side and extending forward thereof, said framework including a plurality of rods connected together such that open spaces are defined between adjacent ones of said rods, said framework being formed in a shape of an animal head, said animal head resembling a dear head, said framework further being formed into a pair of antlers extending off of said animal head;
a plurality of light emitters, each of said light emitters being positioned on said framework and being spaced from each other, said light emitters forming an outline of said animal head and said antlers;
a power supply being electrically coupled to said light emitters, said power supply comprising a battery mounted in said panel, said back side having a door thereon for accessing said battery;
a switch being electrically coupled to said power supply and said light emitters, said switch being actuated to an on position to turn said light emitters on and being actuated to an off position to turn said light emitters off;
a control circuit being electrically coupled to said switch;
a motion sensor being mounted on front side of said panel and being electrically coupled to said control circuit, said control circuit turning said switch to said on position when said motion sensor detects motion to define a motion activation, said control circuit switching said switch to said off position after a predetermined time of said motion activation;
an override button being mounted on said panel and being electrically coupled to said control circuit, said override button being actuated to an on position to turn said light emitters on or to an off position to turn said light emitters off;
a music emitting apparatus being mounted to said panel and being electrically coupled to said control circuit, said music emitting apparatus being turned on and audibly emitting music when said light emitters are turned on, said music emitting apparatus including:
an electronic memory having at least one song stored thereon, said electronic memory being electrically coupled to said control circuit; and
a speaker being electrically coupled to said control circuit.
